(19) United States
(12) Patent Application Publication
(10) Pub. No.: US 2010/0089046 A1
(43) Pub. Date: Apr. 15, 2010

(54) LOCKUP DEVICE AND FLUID TORQUE TRANSMISSION DEVICE EQUIPPED WITH SAME

(75) Inventor: Naoki Tomiyama, Osaka (JP)

Correspondence Address: GLOBAL IP COUNSELORS, LLP, 1233 20TH STREET, NW, SUITE 700, WASHINGTON, DC, 20036-2680, US

(73) Assignee: EXEDY CORPORATION, Neyagawa-shi, Osaka (JP)

(21) Appl. No.: 12/446,874

(22) PCT Filed: Dec. 4, 2007
(86) PCT No.: PCT/JP2007/073386

§ 371 Date: Apr. 23, 2009

(30) Foreign Application Priority Data
Dec. 7, 2006 (JP) 2006-331030

(51) Int. Cl. F16H 45/02

(52) U.S. Cl. 60/364

(57) ABSTRACT

A lockup device (7) of a torque converter (1) has a piston (75), a piston linking mechanism (76), a clutch plate (71), and a damper mechanism (9). The piston linking mechanism (76) links the piston (75) to a front cover (11) rotatably in the rotational direction and movably in the axial direction, and restricts movement of the piston (75) to a turbine (22) side to within a specific range.

### TECHNICAL FIELD

The present invention relates to a lockup device for a fluid torque transmission device, and more particularly relates to a lockup device in which a front cover and a piston are linked.

### BACKGROUND ART

A torque converter is a known example of a fluid torque transmission device. A torque converter has three kinds of vane wheels inside (an impeller, a turbine, and a stator), and transmits torque via internal hydraulic fluid. A torque converter such as this is usually provided with a lockup device.

A lockup device is disposed in the space between the turbine and the front cover in the fluid chamber formed by the turbine and the front cover, and is a mechanism for directly transmitting torque from the front cover to the turbine by mechanically linking the front cover and the turbine.

This lockup device is usually made up of a disk-shaped piston that can be pressed against the front cover, a friction plate that is sandwiched between the piston and the front cover, a damper mechanism that can elastically link the front cover and the turbine in the rotational direction via the friction plate, and a linking mechanism that links the piston and the front cover.

The damper mechanism has a driven plate that is fixed to the turbine, a drive plate that integrally, rotatably, and movably engages with the friction plate in the axial direction, and a torsion spring that elastically links the drive plate and the driven plate in the rotational direction.

The linking mechanism integrally, rotatably, and movably links the piston to the front cover in the axial direction. The piston is rotatably and movably supported by a turbine hub in the axial direction (see Japanese Laid-Open Patent Application 2001-500237, for example).

When the lockup device is engaged, hydraulic pressure moves the piston to the front cover side, and the friction plate is squeezed between the piston and the front cover. As a result, torque is transmitted from the front cover to the friction plate, and is further transmitted to the turbine via the torsion spring. The torsion spring is compressed in the rotational direction between the driven plate and the drive plate, and absorbs and damps torsional vibration.

Meanwhile, when the lockup device is disengaged, hydraulic pressure moves the piston to the turbine side, and the friction plate is able to rotate with respect to the piston and the front cover. As a result, torque is not transmitted via the lockup device, and instead torque is transmitted from the impeller to the turbine via the fluid.

### SUMMARY OF THE INVENTION

### Technical Problem

With this lockup device, movement of the piston to the turbine side is restricted by the turbine hub. When the device is engaged and the piston moves to the turbine side, the turbine hub slides with a cylindrical distal end formed on the inner peripheral side of the piston. As a result, when used for an extended period, the cylindrical distal end and the turbine hub may seize or wear down so that the piston interferes with the drive plate or the torsion spring, preventing normal operation.

It is an object of the present invention to prevent the wear of members that accompanies movement of the piston in the axial direction, and to reduce friction loss, in a lockup device of a fluid torque transmission device.

### Technical Solution

The lockup device according to a first aspect of the present invention is used in a fluid torque transmission device that includes a front cover to which torque is inputted, an impeller that is fixed to the front cover and that forms a fluid chamber filled with hydraulic fluid, and a turbine disposed opposite the impeller. The lockup device is disposed in the space between the front cover and the turbine, and mechanically links the front cover and the turbine. The lockup device comprises a piston, a piston linking mechanism, a friction plate, and a damper mechanism. The piston is provided movably in the axial direction and rotatably with respect to the turbine, and is able to move in the axial direction according to the pressure of the hydraulic fluid. The piston linking mechanism links the piston movably in the axial direction and integrally rotatably with respect to the front cover, and restricts movement of the piston to the turbine side to within a specific range. The friction plate is sandwiched in the axial direction between the piston and the front cover by movement of the piston to the front cover side. The damper mechanism is capable of elastically linking the front cover and the turbine in the rotational direction via the friction plate.

With this lockup device, movement of the piston to the turbine side is restricted to within a specific range by the piston linking mechanism. Accordingly, movement of the piston can be restricted to the portion where no relative rotation occurs. Consequently, this prevents wear to members that accompanies movement of the piston in the axial direction, and friction loss can be reduced.

The lockup device according to a second aspect of the present invention is the device of the first aspect, wherein the piston linking mechanism has a first member that is fixed to the front cover, a second member that is fixed to the piston, and a restricting member that restricts movement of the second member to the turbine side with respect to the first member to within a specific range.

The lockup device according to a third aspect of the present invention is the device of the second aspect, wherein the first member and the second member have portions that intersect in the axial direction. The restricting member engages with the intersecting portions.

The lockup device according to a fourth aspect of the present invention is the device pertaining to the third aspect, wherein the first member has a first annular component that is fixed to the front cover, and a plurality of first inner peripheral teeth that extends inward in the radial direction from the first annular component. The second member has a second annular component that is fixed to the turbine, and a plurality of second inner peripheral teeth that extends inward in the radial direction from the second annular component. The first and second inner peripheral teeth mesh in the rotational direction in a state of intersecting in the axial direction.

The lockup device according to a fifth aspect of the present invention is the device of the fourth aspect, wherein the first inner peripheral teeth have a first distal end component that extends inward in the radial direction. The second inner peripheral teeth have a second distal end component that extends inward in the radial direction and is disposed more to the front cover side than the first distal end component. The restricting member is a ring member that is disposed in the axial direction between the first and second distal end components and whose outside diameter changes under external force.

The lockup device according to a sixth aspect of the present invention is the device of the fifth aspect, wherein the first inner peripheral teeth extend inward in the radial direction and have a first intersecting component that extends in the axial direction. The second inner peripheral teeth mesh with the first intersecting component in the rotational direction.

The lockup device according to a seventh aspect of the present invention is the device of the fifth or sixth aspects, wherein the second inner peripheral teeth extend inward in the radial direction and have a second intersecting component that extends in the axial direction. The first inner peripheral teeth mesh with the second intersecting component in the rotational direction.

The lockup device according to an eighth aspect of the present invention is the device of any one of the fourth to seventh aspects, wherein the first member further has a plurality of first outer peripheral teeth that extends inward in the radial direction from the first annular component. The second member further has a plurality of second outer peripheral teeth that extend inward in the radial direction from the second annular component and mesh with the first outer peripheral teeth in the rotational direction.

The lockup device according to a ninth aspect of the present invention is the device of any one of the second to eighth aspects, wherein the inside diameter of the piston is greater than the inside diameter of the first member.

The lockup device according to a tenth aspect of the present invention is the device of any one of the first to ninth aspects, wherein the piston linking mechanism links the inner peripheral part of the front cover and the inner peripheral part of the piston.

Consequently, there is a larger space on the outer peripheral side of the portion where the piston linking mechanism is provided. Accordingly, the elastic member used for the damper mechanism can be larger, and this affords greater latitude in design.

The fluid torque transmission device according to an eleventh aspect of the present invention is a fluid torque transmission device for transmitting torque from an engine to the transmission side, comprising a front cover to which torque is inputted, an impeller that is fixed to the front cover and that forms a fluid chamber filled with hydraulic fluid, a turbine disposed opposite the impeller, and the lockup device according to any of the first to tenth inventions. The impeller is fixed to the front cover and forms a fluid chamber that is filled with hydraulic fluid. The turbine is disposed opposite the impeller.

Because this fluid torque transmission device is equipped with the lockup device according to any of the first to tenth inventions, wear and interference between the piston and the damper component are prevented.

### BRIEF DESCRIPTION OF DRAWINGS

FIG. 1 is a simplified vertical cross section of a torque converter;

FIG. 2 is a partial cross section of a piston linking mechanism;

FIGS. 3a and 3b respectively are an elevational view and cross section of a first plate;

FIGS. 4 and 4b respectively are an elevational view and cross section of a second plate;

FIGS. 5a and 5b respectively are an elevational view and cross section of a wire ring; and

FIG. 6 is an assembly diagram.

### DESCRIPTION OF REFERENCE NUMERALS

### Detailed Description of the Preferred Embodiments of the Invention

An embodiment pertaining to the lockup device 7 of the present invention will now be described on the basis of the drawings. A torque converter 1 in which the lockup device 7 is installed will be used as an example here.

### (1) Basic Configuration of Torque Converter

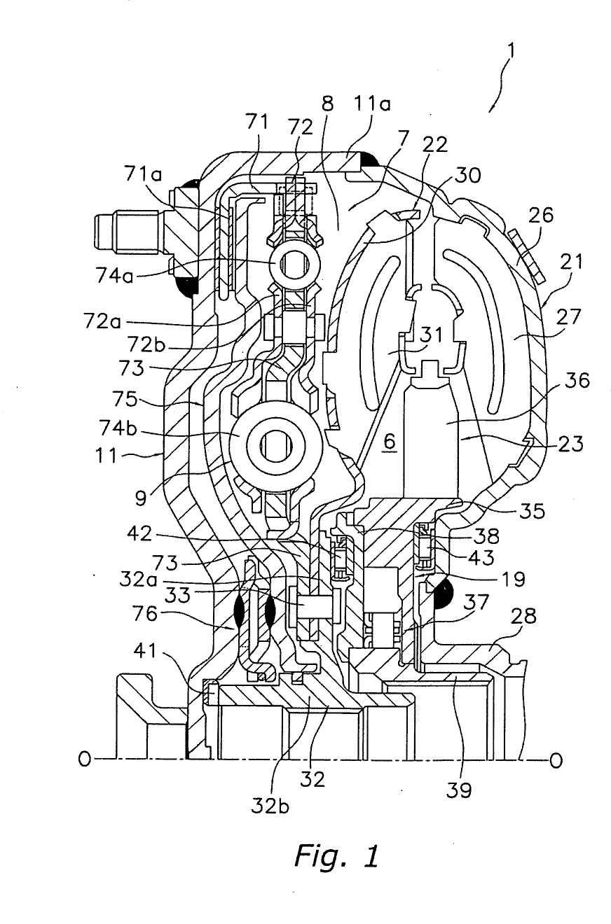

The basic configuration of the torque converter 1 will be described through reference to FIG. 1. FIG. 1 is a simplified vertical cross section of the torque converter 1. The torque converter 1 is a device for transmitting torque from the crankshaft (not shown) of an engine to the input shaft (not shown) of a transmission. The engine (not shown) is disposed on the left side in FIG. 1, and the transmission (not shown) is disposed on the right side in FIG. 1. The line O-O in FIG. 1 is the rotational axis of the torque converter 1.

The torque converter 1 mainly comprises a front cover 11 that is linked to a member on the engine side (not shown), three kinds of vane wheels (an impeller 21, a turbine 22, and a stator 23), and the lockup device 7. A fluid chamber is formed by the front cover 11 and the impeller 21. This fluid chamber is filled with hydraulic fluid. The fluid chamber is divided into a torus-shaped fluid working chamber 6 surrounded by the turbine 22 and the stator 23, and an annular space 8 in which the lockup device 7 is disposed.

An outer peripheral cylindrical component 11a that extends to the transmission side is formed on the outer peripheral part of the front cover 11. The outer peripheral edge of an impeller shell 26 of the impeller 21 is fixed by welding or the like to the distal end of this outer peripheral cylindrical component 11a. A fluid chamber that is filled with hydraulic fluid is formed by the front cover 11 and the impeller 21.

The impeller 21 mainly comprises the impeller shell 26, a plurality of impeller blades 27 fixed on the inside thereof, and an impeller hub 28 that is fixed by welding or the like to the inner peripheral part of the impeller shell 26.

The turbine 22 is disposed opposite the impeller 21 in the axial direction inside the fluid chamber. The turbine 22 mainly comprises a turbine shell 30, a plurality of turbine blades 31 fixed to a face on the impeller 21 side thereof, and a turbine hub 32 that is fixed to the inner peripheral edge of the turbine shell 30. The turbine hub 32 comprises a flange 32a and a boss 32b. The turbine shell 30 and the turbine hub 32 are fixed by a plurality of rivets 33 to the flange 32a of the turbine hub 32 along with a driven plate 73 of a damper mechanism 9. A spline that engages an input shaft (not shown) is formed on the inner peripheral face of the boss 32b of the turbine hub 32. The turbine hub 32 rotates integrally with the input shaft.

The stator 23 is provided in the axial direction between the inner peripheral part of the impeller 21 and the inner peripheral part of the turbine 22, and is a mechanism for adjusting the flow of hydraulic fluid returning from the turbine 22 to the impeller 21. The stator 23 mainly comprises an annular stator carrier 35 and a plurality of stator plates 36 provided to the outer peripheral face of the stator carrier 35. The stator carrier 35 is supported by a cylindrical fixed shaft 39 via a one-way clutch 37. The fixed shaft 39 extends toward the transmission side in the axial direction between the outer peripheral face of the input shaft and the inner peripheral face of the impeller hub 28.

A first thrust bearing 41 is disposed between the front cover 11 and the boss 32b, which bears the thrust force generated by rotation of the turbine 22. A second thrust bearing 42 is disposed between the inner peripheral part of the flange 32a and the inner peripheral part of the stator 23 (more precisely, a retainer 38). A third thrust bearing 43 is disposed in the axial direction between the stator carrier 35 and the impeller hub 28.

### (2) Structure of Lockup Device

As shown in FIG. 1, the lockup device 7 is disposed in the space 8 between the turbine 22 and the front cover 11, and is a mechanism for mechanically linking these two as needed. The lockup device 7 has a clutch function and a damper function, and mainly comprises a clutch plate 71 (as a friction plate), the damper mechanism 9, a piston 75, and a piston linking mechanism 76.

The clutch plate 71 is an annular member having a friction member 71a, and engages integrally rotatably and movably in the axial direction with the outer peripheral part of a drive plate 72. The portion where the friction member 71a is provided is disposed in the axial direction between the front cover 11 and the piston 75.

The damper mechanism 9 is able to link elastically the front cover 11 and the turbine 22 in the rotational direction via the clutch plate 71. The damper mechanism 9 mainly comprises the drive plate 72, the driven plate 73, a first torsion spring 74a, and a second torsion spring 74b.

The drive plate 72 is made up of two plate members 72a and 72b, and supports the first torsion spring 74a and the second torsion spring 74b. The driven plate 73 is disposed in the axial direction between the plate members 72a and 72b, and is able to rotate within a specific range with respect to the drive plate 72. The drive plate 72 and the driven plate 73 are elastically linked in the rotational direction by the first torsion spring 74a and the second torsion spring 74b. The first torsion spring 74a, and the second torsion spring 74b are disposed in parallel.

The piston 75 is disposed in the axial direction between the front cover 11 and the damper mechanism 9, and is supported by the turbine hub 32 rotatably and movably in the axial direction. The piston 75 is able to move in the axial direction according to the pressure of the hydraulic fluid, and is able to press against the front cover 11 and release this pressing. The piston 75 is linked to the front cover 11 by the piston linking mechanism 76 disposed on the inner peripheral side of the damper mechanism 9.

### (3) Configuration of Piston Linking Mechanism

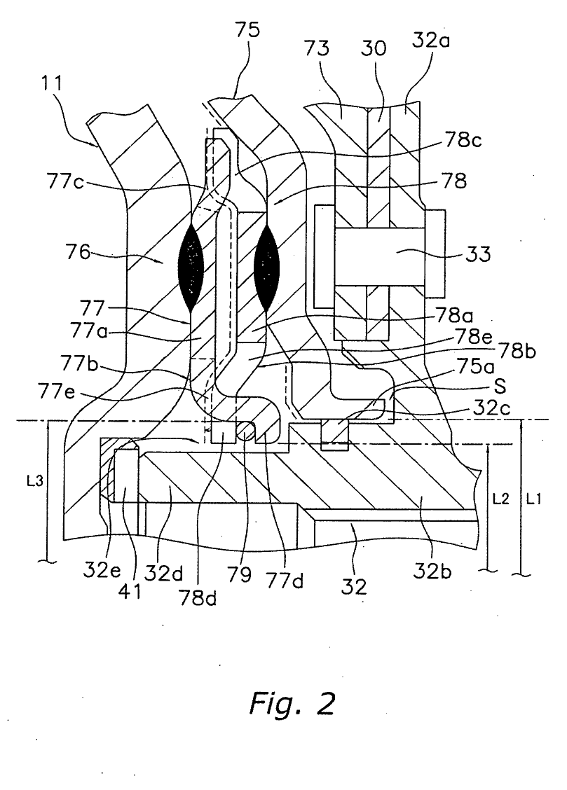

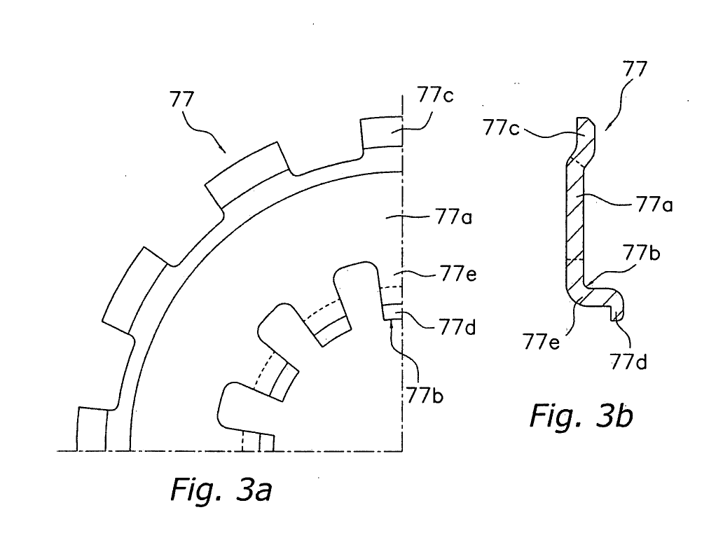

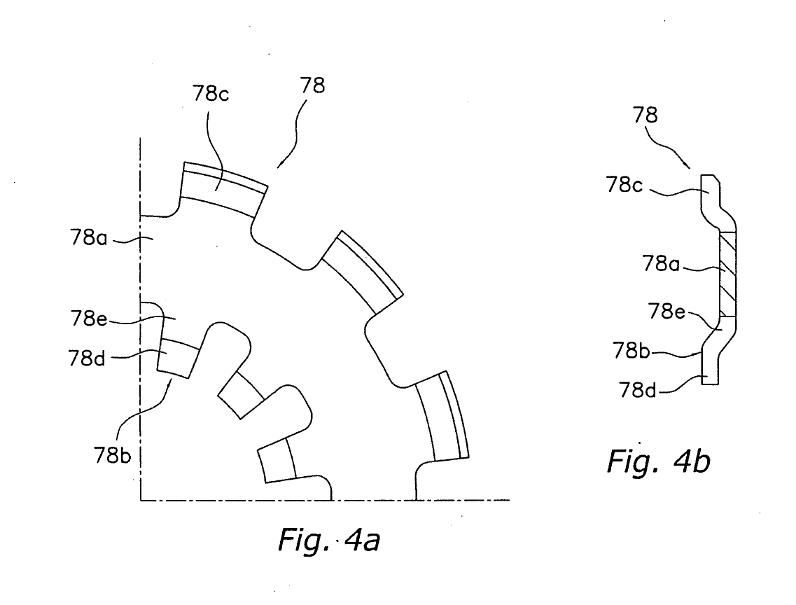

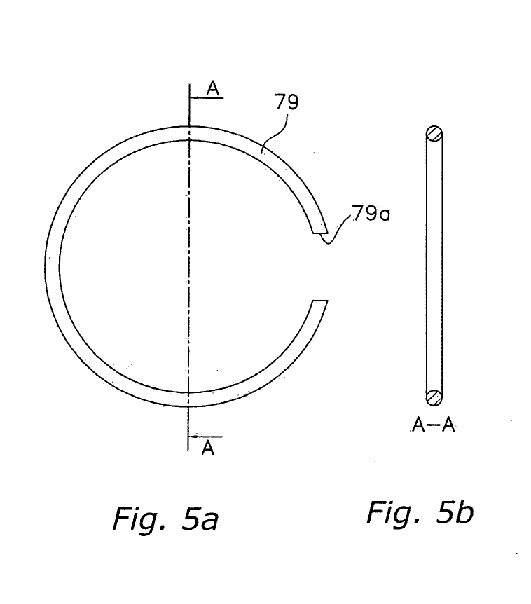

The piston linking mechanism 76 will be described in detail through reference to FIGS. 1 to 5. FIG. 2 is a partial cross section of the piston linking mechanism 76, FIGS. 3a and 3b respectively are an elevational view and cross section of a first plate 77, FIGS. 4a and 4b respectively are an elevational view and cross section of a second plate 78, and FIGS. 5a and 5b are respectively an elevational view and cross section of a wire ring 79.

As shown in FIG. 1, the piston linking mechanism 76 integrally, rotatably, and movably links the piston 75 to the front cover 11 in the axial direction. The piston linking mechanism 76 is disposed on the inner peripheral side of the damper mechanism 9, and links the inner peripheral part of the piston 75 with the inner peripheral part of the front cover 11.

As shown in FIG. 2, the piston linking mechanism 76 mainly comprises the first plate 77 (as the first member) that is fixed to the front cover 11, the second plate 78 (as the second member) that is fixed to the piston 75, and the wire ring 79 (as the restricting member).

As shown in FIGS. 2 and 3, the first plate 77 comprises a first annular component 77a that is fixed to the front cover 11, a plurality of first inner peripheral teeth 77b, and a plurality of first outer peripheral teeth 77c. The first plate 77 is formed integrally.

The first inner peripheral teeth 77b are a portion extending inward in the radial direction from the first annular component 77a, and have a first intersecting component 77e and a first distal end component 77d. The first intersecting component 77e is a portion that intersects in the axial direction with second inner peripheral teeth 78b (discussed below).

More specifically, part of the first intersecting component 77e is bent toward the turbine 22 side, and extends in the axial direction. The portion extending in the axial direction intersects with the second inner peripheral teeth 78b. The first distal end component 77d is a portion that extends inward in the radial direction from the distal end of the first intersecting component 77e, and is able to come into contact with the wire ring 79 in the axial direction.

The first outer peripheral teeth 77c is a portion that extends inward in the radial direction from the first annular component 77a, is superposed in the axial direction with second outer peripheral teeth 78c (discussed below), and does not intersect with the second outer peripheral teeth 78c in the axial direction.

As shown in FIGS. 2 and 4, the second plate 78 comprises a second annular component 78a that is fixed to the piston 75, the plurality of second inner peripheral teeth 78b, and the plurality of second outer peripheral teeth 78c. The second plate 78 is formed integrally.

The second inner peripheral teeth 78b is a portion that extends inward in the radial direction from the second annular component 78a, and has a second intersecting component 78e and a second distal end component 78d. The second intersecting component 78e is a portion that intersects in the axial direction with the first intersecting component 77e of the first inner peripheral teeth 77b. More specifically, part of the second intersecting component 78e is bent slightly to the front cover 11 side, and is inclined with respect to the radial direction. The second distal end component 78d is a portion that extends inward in the radial direction from the distal end of the second intersecting component 78e, and is able to come into contact with the wire ring 79 in the axial direction.

The second outer peripheral teeth 78c are a portion that extends inward in the radial direction from the second annular component 78a, and a part thereof is bent to the front cover 11 side. The second outer peripheral teeth 78c are superposed in the axial direction with the first outer peripheral teeth 77c, and do not intersect with the first outer peripheral teeth 77c in the axial direction.

As shown in FIGS. 2 and 5, the wire ring 79 is a substantially annular member that has one part cut out, and has a cut-out 79a. The wire ring 79 can undergo elastic deformation in the radial direction, and its outside diameter changes when subjected to external force.

As shown in FIG. 2, the first inner peripheral teeth 77b are inserted in the axial direction between the second inner peripheral teeth 78b. Accordingly, the first plate 77 and the second plate 78 are able to move in the axial direction. During engagement, the second plate 78 is able to move with respect to the first plate 77 from the state in FIG. 2 by a distance equal to the gap between the clutch plate 71 and the piston 75. The first inner peripheral teeth 77b and the second inner peripheral teeth 78b mesh in the rotational direction. Accordingly, the first plate 77 and the second plate 78 rotate integrally.

The first intersecting component 77e and the second intersecting component 78e intersect in the axial direction. Accordingly, the first distal end component 77d and the second distal end component 78d switch positions in the axial direction. More specifically, whereas the first annular component 77a is disposed on the front cover 11 side of the second annular component, the first distal end component 77d is disposed on the turbine 22 side of the second distal end component 78d.

The wire ring 79 is sandwiched in the axial direction between the first distal end component 77d and the second distal end component 78d. In a state in which the second inner peripheral teeth 78b are inserted between the first inner peripheral teeth 77b, the second distal end component 78d catches on the wire ring 79. Consequently, movement of the second plate 78 to the turbine 22 side is restricted to within a specific range with respect to the first plate 77.

The wire ring 79 is disposed on the inner peripheral side of the first inner peripheral teeth 77b, and is positioned in the radial direction in the portion of the first inner peripheral teeth 77b extending in the axial direction. The wire ring 79 is fitted in a free state.

In the state in FIG. 2, a gap S is ensured in the axial direction between the flange 32a and a cylindrical part 75a of the piston 75. This prevents the cylindrical part 75a from touching the flange 32a.

As described above, the piston linking mechanism 76 links the piston 75 to the front cover 11 movably in the axial direction and integrally rotatably. From the state in FIG. 2, the piston 75 is able to move in the axial direction by a distance equal to the gap from the clutch plate 71 to the front cover 11 side. Meanwhile, movement of the piston 75 to the turbine 22 side with respect to the front cover 11 is restricted by the wire ring 79 via the first plate 77 and the second plate 78.

The piston linking mechanism 76 is also characterized by its dimensional relationship. More specifically, as shown in FIG. 2, if we let the inside diameter of the cylindrical part 75a of the piston 75 (the outside diameter of a sealing member 32c) be a first diameter L1, the inside diameter of the first distal end component 77d (or the second distal end component 78d) be a second diameter L2, and the outside diameter of the wire ring 79 (or the inside diameter of the portion of the first intersecting component 77e extending in the axial direction) be a third diameter L3, then the first diameter L1 is greater than the second diameter L2 and the third diameter L3. Accordingly, when the wire ring 79 is attached from the turbine 22 side, the area around the first distal end component 77d and the second distal end component 78d is easier to see from the turbine 22 side, which makes attachment easier.

Furthermore, the first distal end component 77d, the second distal end component 78d, and the wire ring 79 are disposed so as to be superposed with the boss 32b in the radial direction. More specifically, the turbine hub 32 further has a cylindrical component 32d that extends in the axial direction from the boss 32b. The piston linking mechanism 76 is disposed on the outer peripheral side of the cylindrical component 32d. The outside diameter of the cylindrical component 32d is smaller than the outside diameter of the boss 32b, and a recess 32e is formed by the boss 32b and the cylindrical component 32d. This recess 32e accommodates the first distal end component 77d, the second distal end component 78d, and the wire ring 79. Consequently, the space on the inner peripheral side can be used more effectively, and the space on the outer peripheral side of the piston linking mechanism 76 can be expanded.

### (4) Operation of Torque Converter

The operation of the torque converter 1 will be described through reference to FIG. 1.

When the lockup device 7 is engaged, hydraulic pressure causes the piston 75 to move to the front cover 11 side, and the clutch plate 71 is squeezed between the piston 75 and the front cover 11.

The piston 75 is integrally, rotatably, and movably lined to the front cover 11 in the axial direction by the piston linking mechanism 76. Accordingly, the piston 75 moves to the front cover 11 side while rotating integrally with the front cover 11. Here, movement of the piston 75 in the axial direction is not restricted by the piston linking mechanism 76 (the first plate 77, the second plate 78, and the wire ring 79).

When the clutch plate 71 is squeezed, torque is transmitted from the front cover 11 to the clutch plate 71, and is further transmitted through the drive plate 72, the first and second torsion springs 74a and 74b, and the driven plate 73 to the turbine 22. Torsional vibration is absorbed and damped by the damper mechanism 9.

Meanwhile, when the lockup device 7 is disengaged, hydraulic pressure causes the piston 75 to move to the turbine 22 side, and the squeezing of the clutch plate 71 is released. As a result, the clutch plate 71 is able to rotate with respect to the front cover 11 and the piston 75.

Movement of the piston 75 to the turbine 22 side is restricted to within a specific range by the piston linking mechanism 76. Accordingly, the first distal end component 77d of the first plate 77 and the second distal end component 78d of the second plate 78 hit the wire ring 79, and the piston 75 stops in the state shown in FIG. 2. This prevents the cylindrical part 75a of the piston 75 from touching the flange 32a of the turbine hub 32. At this point the front cover 11 and the piston 75 are rotating integrally. Accordingly, the first plate 77, the second plate 78, and the wire ring 79 do not slide in the rotational direction, which prevents wear of the various members.

The clutch plate 71 is able to rotate with respect to the front cover 11 and the piston 75. Torque is not transmitted through the lockup device 7, and torque is instead transmitted via fluid from the impeller hub 28 to the turbine 22.

As discussed above, with the torque converter 1, torque can be transmitted from the engine to the transmission either via fluid or directly through the lockup device 7.

### (5) Attachment of the Piston Linking Mechanism

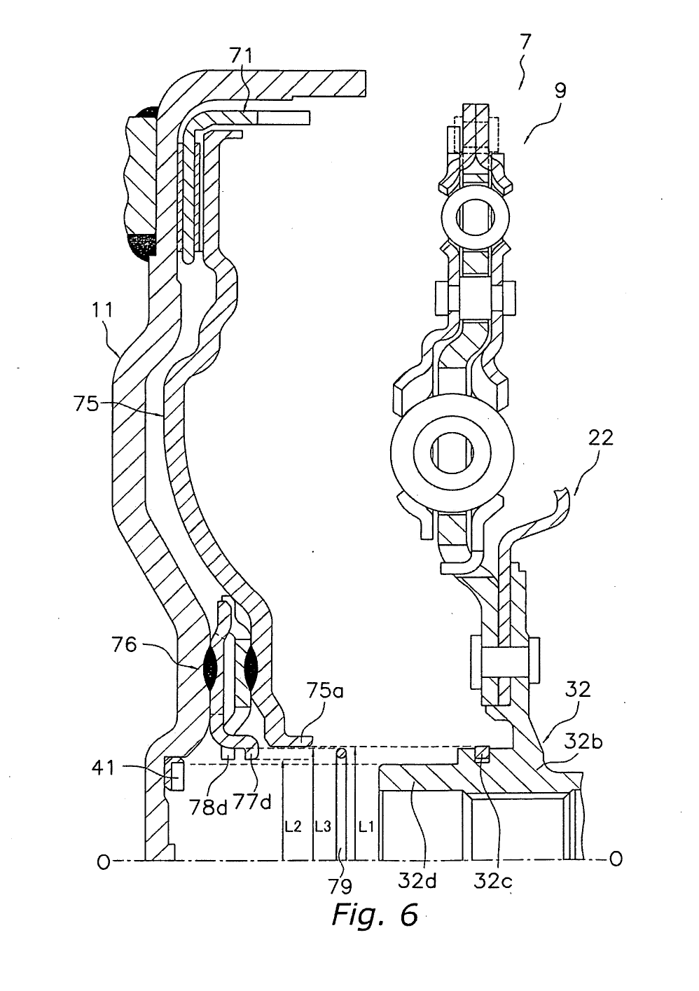

The attachment of the piston linking mechanism 76 will be described through reference to FIG. 6.

As shown in FIG. 6, the first plate 77 of the piston linking mechanism 76 is fixed by welding to the front cover 11. The second plate 78 is fixed by welding to the piston 75. Next, the clutch plate 71, the piston 75, and the first thrust bearing 41 are attached to the front cover 11. The piston 75 is attached so that the first plate 77 and the second plate 78 will mesh. After this, the wire ring 79 is fitted in between the first distal end component 77d and the second distal end component 78d.

Here, since the first diameter L1 of the piston 75 is greater than the second diameter L2 and the third diameter L3 as mentioned above, the area around the first distal end component 77d and the second distal end component 78d is easier to see from the turbine 22 side (the right side in FIG. 6). Consequently, the wire ring 79 is easier to attach.

After the wire ring 79 has been attached, the assembly of the damper mechanism 9, the turbine 22, and the turbine hub 32 is attached.

### (6) Actions and Effects

The actions and effects of the lockup device 7 are compiled below.

(a)

With this lockup device 7, the piston 75 is linked to the front cover 11 by the piston linking mechanism 76 integrally rotatably and movably in the axial direction. In addition, movement of the piston 75 to the turbine 22 side is restricted to within a specific range by the piston linking mechanism 76. Accordingly, movement of the piston 75 can be restricted in the portion where there is no relative rotation, wear of the members that accompanies movement of the piston 75 in the axial direction can be prevented, and friction loss can be reduced.

(b)

With a conventional lockup device, the piston linking mechanism is disposed near the center of the piston in the radial direction. Accordingly, the elastic member of the damper mechanism has to be disposed on the outer peripheral side. Also, when the elastic member is disposed near the center in the radial direction, because the space is tight, the diameter of the elastic member cannot be increased, and this reduces design latitude.

However, with this lockup device 7, the piston linking mechanism 76 is disposed around the inner peripheral part of the piston 75. Accordingly, there is more space on the outer peripheral side of the piston linking mechanism 76, and the diameters of the first torsion spring 74a and second torsion spring 74b of the damper mechanism 9 can be increased. Specifically, greater design latitude is afforded with this lockup device 7.

(c)

With the piston linking mechanism 76, in addition to the first inner peripheral teeth 77b and the second inner peripheral teeth 78b, the first outer peripheral teeth 77c and second outer peripheral teeth 78c disposed on the outer peripheral sides of these also mesh. Accordingly, when the piston 75 and the front cover 11 rotate integrally, there is greater contact surface area in the rotational direction. This means that the surface pressure is lower at the contact portion, and wear of the first plate 77 and second plate 78 can be reduced.

(d)

With this lockup device 7, the wire ring 79 of the piston linking mechanism 76 is attached from the inner peripheral side. Also, the first diameter L1 of the piston 75 is greater than the second diameter L2 of the piston linking mechanism 76. Accordingly, the place where the wire ring 79 is attached is easier to see during attachment, and this facilitates attachment. Also, even if some problem should occur in the attachment parts, they can be easily disassembled and replaced with new parts.

### (6) Other Embodiments

The specific constitution of the present invention is not limited to the embodiment given above, and various modifications and changes are possible without departing from the gist of the invention.

(a)

The shape of the piston linking mechanism 76 is not limited to that in the above embodiment. For example, the first plate 77 and the second plate 78 may be switched around. More specifically, the portion of the first inner peripheral teeth 77b extending in the axial direction may be formed on the second inner peripheral teeth 78b, and may be formed on either the first inner peripheral teeth 77b or the second inner peripheral teeth 78b.

(b)

The wire ring 79 is used in the piston linking mechanism 76 in the embodiment given above, but this is not the only option. For example, the first plate 77 and the second plate 78 may engage in the axial direction.

(c)

In the above embodiment, the first outer peripheral teeth 77c and the second outer peripheral teeth 78c do not intersect in the axial direction. However, the first outer peripheral teeth 77c and the second outer peripheral teeth 78c may intersect in the axial direction.

(d)

In the above embodiment, the wire ring 79 is attached to the first inner peripheral teeth 77b and the second inner peripheral teeth 78b, but the wire ring 79 may be attached in a state of being compressed in the radial direction.

### INDUSTRIAL APPLICABILITY

With the lockup device and fluid torque transmission device pertaining to the present invention, the constitution described above prevents wear of the members that would accompany movement of the piston in the axial direction, and reduces friction loss. Therefore, the present invention is useful in the field of power transmission devices.

1. A lockup device in a fluid torque transmission device having a front cover to which torque is inputted, an impeller being fixed to the front cover and that forms forming a fluid chamber filled with hydraulic fluid, and a turbine being disposed opposite the impeller, the lockup device being disposed in a space between the front cover and the turbine mechanically linking the front cover and the turbine, the lockup device comprising:
a piston being provided movably in the axial direction and rotatably with respect to the turbine, and being movable in the axial direction according to the pressure of the hydraulic fluid;
a piston linking mechanism linking the piston movably in the axial direction and integrally and rotatably with respect to the front cover, and the piston linking mechanism restricting movement of the piston to the turbine side to within a specific range;
a friction plate being sandwiched in the axial direction between the piston and the front cover by movement of the piston to the front cover side; and
a damper mechanism elastically linking the front cover and the turbine in the rotational direction via the friction plate.

2. The lockup device according to claim 1, wherein
the piston linking mechanism has a first member that is fixed to the front cover, a second member that is fixed to the piston, and a restricting member that restricts movement of the second member to the turbine side with respect to the first member to within a specific range.

3. The lockup device according to claim 2, wherein
the first member and the second member have portions that intersect in the axial direction, and
the restricting member engages with the intersecting portions.

4. The lockup device according to claim 3, wherein
the first member has a first annular component that is fixed to the front cover, and a plurality of first inner peripheral teeth that extends inward in the radial direction from the first annular component,
the second member has a second annular component that is fixed to the turbine, and a plurality of second inner peripheral teeth that extends inward in the radial direction from the second annular component, and
the first and second inner peripheral teeth mesh in the rotational direction in an intersecting state in the axial direction.

5. The lockup device according to claim 4, wherein
the first inner peripheral teeth have a first distal end component that extends inward in the radial direction,
the second inner peripheral teeth have a second distal end component that extends inward in the radial direction and is disposed more to the front cover side than the first distal end component, and
the restricting member is a ring member that is disposed in the axial direction between the first and second distal end components and whose outside diameter changes under external force.

6. The lockup device according to claim 5, wherein
the first inner peripheral teeth extend inward in the radial direction and have a first intersecting component that extends in the axial direction, and
the second inner peripheral teeth mesh with the first intersecting component in the rotational direction.

7. The lockup device according to claim 6, wherein
the second inner peripheral teeth extend inward in the radial direction and have a second intersecting component that extends in the axial direction, and
the first inner peripheral teeth mesh with the second intersecting component in the rotational direction.

8. The lockup device according to claim 7, wherein
the first member further has a plurality of first outer peripheral teeth that extends inward in the radial direction from the first annular component, and
the second member further has a plurality of second outer peripheral teeth that extends inward in the radial direction from the second annular component and mesh with the first outer peripheral teeth in the rotational direction.

9. The lockup device according to claim 8, wherein
the inside diameter of the piston is greater than the inside diameter of the first member.

10. The lockup device according to claim 9, wherein
the piston linking mechanism links an inner peripheral part of the front cover and an inner peripheral part of the piston.

11. A fluid torque transmission device for transmitting torque from an engine to the transmission side, comprising:
a front cover to which torque is inputted;
an impeller being fixed to the front cover and forming a fluid chamber filled with hydraulic fluid;
a turbine being disposed opposite the impeller; and
the lockup device according to claim 10.

12. The lockup device according to claim 6, wherein
the first member further has a plurality of first outer peripheral teeth that extends inward in the radial direction from the first annular component, and
the second member further has a plurality of second outer peripheral teeth that extends inward in the radial direction from the second annular component and mesh with the first outer peripheral teeth in the rotational direction.

13. The lockup device according to claim 5, wherein
the second inner peripheral teeth extend inward in the radial direction and have a second intersecting component that extends in the axial direction, and
the first inner peripheral teeth mesh with the second intersecting component in the rotational direction.

14. The lockup device according to claim 13, wherein
the first member further has a plurality of first outer peripheral teeth that extends inward in the radial direction from the first annular component, and
the second member further has a plurality of second outer peripheral teeth that extends inward in the radial direction from the second annular component and mesh with the first outer peripheral teeth in the rotational direction.

15. The lockup device according to claim 14, wherein
the inside diameter of the piston is greater than the inside diameter of the first member.

16. The lockup device according to claim 5, wherein
the first member further has a plurality of first outer peripheral teeth that extends inward in the radial direction from the first annular component, and
the second member further has a plurality of second outer peripheral teeth that extends inward in the radial direction from the second annular component and mesh with the first outer peripheral teeth in the rotational direction.

17. The lockup device according to claim 4, wherein
the first member further has a plurality of first outer peripheral teeth that extends inward in the radial direction from the first annular component, and
the second member further has a plurality of second outer peripheral teeth that extends inward in the radial direction from the second annular component and mesh with the first outer peripheral teeth in the rotational direction.

18. The lockup device according to claim 2, wherein
the inside diameter of the piston is greater than the inside diameter of the first member.

19. The lockup device according to claim 1, wherein
the piston linking mechanism links an inner peripheral part of the front cover and an inner peripheral part of the piston.

20. A fluid torque transmission device for transmitting torque from an engine to the transmission side, comprising:
a front cover to which torque is inputted;
an impeller being fixed to the front cover and forming a fluid chamber filled with hydraulic fluid;
a turbine being disposed opposite the impeller; and
the lockup device according to claim 1.
